(19) United States
(12) Patent Application Publication
(10) Pub. No.: US 2018/0352840 A1
(43) Pub. Date: Dec. 13, 2018

(54) NATURAL INSTANT SOUP WITH LOW GLYCAEMIC INDEX

(71) Applicant: TUBITAK, Ankara (TR)

(72) Inventors: Tarlk ÖZTÜRK, Kocaeli (TR); Bahar TOPAL, Kocaeli (TR)

(73) Assignee: TUBITAK, Ankara (TR)

(21) Appl. No.: 15/780,632

(22) PCT Filed: Nov. 25, 2016
(86) PCT No.: PCT/IB2016/057131

§ 371 Date: May 31, 2018

(30) Foreign Application Priority Data
Dec. 1, 2015 (TR) TR 2015/15234

(51) Int. Cl. A23L 23/10; A23L 11/00; A23L 11/30; A23N 12/08

(52) U.S. Cl. CPC A23L 23/10; A23N 12/083; A23L 11/30; A23L 11/05

(57) ABSTRACT

The scope of this invention is a production method on a powdered mixture that does not contain any food additives and gives a thick low glycaemic index soup by adding hot water. Industrially produced soups and instant soups are present on the market. These kinds of soups have some certain disadvantages for consumers. These kinds of soups need additives to give flavour, take a long time to be prepared, have high glycaemic indices, and can clump with hot water. A thick instant soup with no visible phase separation can be obtained by applying at least one wetting, two tempering, and one roasting process to chickpeas for any time and adding necessary savour substances and water above 80° C. to the powdered product.

### CROSS REFERENCE TO RELATED APPLICATIONS

This application is the national phase entry of International Application No. PCT/IB2016/057131, filed on Nov. 25, 2016, which is based upon and claims priority to Turkish Patent Application No. 2015/15234, filed on Dec. 1, 2015, the entire contents of which are incorporated herein by reference.

### TECHNICAL FIELD

The topic of this invention is the production method of a powder mixture which does not contain any food additive and can turn into a low glycaemic index consistent soup when mixed with hot water.

### BACKGROUND

There are lots of industrially made soups and instant soup mixtures in the market. These industrially made soups generally contain pre-dried or pre-cooked vegetables and legumes with starch based components that provides gelation and the flavour of these are improved either with monosodium glutamate or another flavour enhancers as yeast extract, hydrolysed vegetable protein. These kinds of soups have some certain disadvantages for the consumers.

These soups need food additives for flavour, their preparation time can be long, their glycaemic indices are high, and they can flocculate with hot water.

Instant soups are developed to reduce the long cooking time of industrially made soups. In instant soups the components are cooked and grounded to small pieces and some consistency enhancers are added. These consistency enhancers have generally high glycaemic indices.

Monosodium glumate, yeast extract, hydrolysed vegetable protein are needed for flavour enhancing of the soups.

The US pea and lentil council declared that the instant soups can be prepared by drying of the puree after boiling and mashing of the legumes.

In U.S. Pat. No. 5,863,592A the problems which were encountered in the previous method as not dissolving in water, forming irregular texture and flocculating were resolved by awaiting the legumes in water and cooking them in steam following their mashing and drying to form instant pea granules. The method that is declared in U.S. Pat. No. 5,863,592A recommends a solution for the production of a powder which dissolves easier than pea, however it does not mention a solution for flavour. Besides in U.S. Pat. No. 5,863,592A patent, the chickpeas are cooked, mashed and turned into powder by drying. The flour is not obtained from whole the chickpeas treated with a peculiar process.

In WO2007006383 A2 patent application, plants that are rich in starch are steeped in water and softened, their cells are released with various solutions and enzymes, after that they are percolated and dried. With this method low glycaemic indexed products can be obtained.

However there is no information about instant solubility properties and taste of these products.

Besides in this patent the whole chickpeas are not dried but the puree or liquid that is obtained by shattering is dried.

US lentil and pea council recommends roasting of legume flours due to their positive contribution to flavour. Roasting process generally contributes the partial degradation of starch and addition of roasted legume flour into the floury products generally gives positive results. However also in this process the chickpeas are shattered into pieces and processed, the whole chickpeas are not grounded after a special process.

Roasted chickpea is a product that is produced with mastery in small scale rather than industrial scale. US lentil and pea council states that the physical and chemical processes occurring through the production of roasted chickpea from chickpea are not exactly known but the occurring processes have different effects of the cooking or roasting of the chickpeas.

One of the most important indicators of these processes is the gain of lots of air gaps of the structure however normally the chickpeas don't have any air gaps.

The starch in chickpeas neither pre-gelatinizes due to boiling of the chickpeas, nor is roasted as in the roasting of chickpea flour. Roasted chickpeas are produced according to regions' peculiar procedures. However in the basic chickpea production the chickpeas are classified according to their sizes, the classified chickpeas are steeped in water and assured to be swollen. Swollen chickpeas are tempered at 5-8 min at 100° C. or 10-15 min at 70-80° C. After the tempering, chickpeas are rested in various durations but generally 30 days in burlap sacks or wood surfaces. After resting phase they are again steeped into water according to their region and treated either at 100° C. 5-8 min or at 70-80° C. 10-15 min again. After tempering roasted chickpeas are rested up to 60 days. After this phase roasted chickpeas can either be tempered and rested or can be roasted. Before the roasting process roasted chickpeas can be wetted according to their region. Roasting process is executed at 6-7 min 100-150° C. after a preheat treatment at 50-60° C. The outer shells of the roasted chickpeas are removed with a utensil called mafrak.

The process that is subjected to patent is soaking of the chickpeas at least once, tempered twice in different times, and roasting at least once prior to turning into flour. It is known for years that chickpeas that are processed like roasted chickpeas have low glycaemic indices.

Roasted chickpea flour has found versatile usage areas. These usage areas are using of it as a snack by mixing it with powdered sugar for children, halvah formed by roasting, filling material for adulteration purpose and addition of it into cakes. Also flour obtained by grinding roasted chickpeas which are roasted for a second time is used to make soup by searing with butter and boiling after addition of cold water and meat broth as known from other floury soups.

### SUMMARY

The chickpeas that are used in this soup are at least once wetted, tempered twice at different times, and roasted at least once prior to turned into flour. In the depicted soup, unlike the roasted chickpeas in the roasted chickpea flour, roasted chickpeas which are extra roasted are used. Roasted chickpeas are ground and roasted with butter and then boiled with cold water.

However in this patent flour is not roasted and not cooked with the addition of cold water. In this patent 85-100° C. water is added to flour and savour mixture and a consistent product is obtained. By this method butter and roasted flour do not turn into a more degraded form and the addition of hot water is possible. Due to adding hot water instead of cold water, cooking process is not needed, and the phase separation due to cold water addition is not observed.

This process also solves the constant stir up problem in order to inhibit the phase separation during cooking process.

It is not possible to obtain soup by addition of hot water to starch rich products as starch is not treated by the described process which is declared in this patent due to clumping of starch.

For this reason products that are rich in starch are added to hot meals by mixing with cold liquids or they are made to boil with cold water as is given in this recipe.

The most substantial characteristics of this flour obtained by this process is ability to form texture without clumping by the addition of hot water but absorbing cold water in limited amounts causing phase separation.

Besides, a patent about extruded product process was encountered after dough production from roasted chickpea flour.

However the usage of roasted chickpea as an instant thickener or an instant soup was not encountered.

Any patent describing not only roasted chickpea but also chickpea in which they are wetted at least once, tempered twice in different times, and at least roasted once was not encountered.

### DETAILED DESCRIPTION OF THE EMBODIMENTS

The invention covers steps below.
1) Wetting and letting chickpeas swell if they are dry
2) Tempering wetted or fresh chickpeas for 1-60 minutes at 50-150° C.
3) Resting tempered chickpeas between 1-100 days
4) Wetting rested chickpeas and tempering them for 1-60 minutes at 50-150° C.
5) Resting tempered chickpeas between 1-100 days
6) Roasting tempered chickpeas for 1-60 minutes at 80-300° C.
7) Removing chickpea skin by a utensil called mafrak during or after roasting
8) Grinding chickpea or broken chickpea by a roller, bladed, bead, or another mill
9) Addition of one or a mixture of some substances among milk powder, whey powder, yoghurt powder, cheese powder, dried fruits or vegetables, spices, savour such as salt or sugar to the obtained chickpea powder
10) Consumption of this mixture by the addition of a liquid at 85-100° C.

Chickpeas can be sorted according to their size prior the operation at the first step to obtain a more homogeneous product and they absorb water and are tempered at the same time for ease of the process.

The wetting step is applied to dried chickpeas but the wetting of fresh chickpeas or addition of any acidity regulator, any salt, enzyme or savour is not out of the scope of this patent. At this step chickpeas are wetted with water between 0-100° C. and water absorption between 10% to 500% of their weight is provided.

Although chickpeas are tempered at the second step preferably at 100° C. for 5-8 minutes or at 70-80° C. for 10-15 minutes, tempering chickpeas at 50-150° C. for 1-60 minutes is also in the scope of this patent.

Although chickpeas are rested preferably on wood surfaces or burlap sacks at the third step, resting chickpeas between 0-60° C. in any container or surface where moisture or gas composition are controlled is not out of the scope of this patent. Although the resting time is between 1-100 days, resting operations shorter than 1 day or longer than 100 days are not out of the topic of this invention.

At the fourth step, re-wetting and not re-wetting of rested chick peas are covered. Although chickpeas are preferably tempered at 100° C. for 5-8 minutes or at 70-80° C. for 10-15 minutes, their tempering at 50-150° C. for 1-60 minutes is also in the scope of this patent.

Although chickpeas are rested preferably on wood surfaces or burlap sacks at the fifth step, resting chickpeas between 0-60° C. in any container or surface where moisture or gas composition are controlled is not out of the scope of this patent. Although the resting time is between 1-100 days, resting operations shorter than 1 day or longer than 100 days are not out of the topic of this invention.

Although chickpeas are preferably roasted at 100-150° C. for 6-7 minutes after a pre heating step at 50-60° C. at the sixth step, roasting operations at different time and temperature are also in the scope of this patent.

Although skin separation is done by a utensil called mafrak at the seventh step, other processes where the skin is removed from chickpea by other methods are also in the scope.

The chickpea skin can be separated from ground chickpea by sieving, separation by air or a cyclone according to its density. Besides grinding of the chickpeas into flour, any other process as sieving of the powder product can be done.

Chickpeas have to be ground at the eighth step so that they pass through a sieve of minimum 355 micron. If all particles are not ground after milling operation at step 8 the chickpea powder can be sieved through a 350 micron sieve. However, if it the presence of low thickening particles in soup does not cause a problem, the amount of chickpea can be increased to adjust the amount of particle concentration under 350 micron with thickening properties.

At the ninth step, addition of one or a mixture of some substances among milk powder, whey powder, yoghurt powder, cheese powder, dried fruits or vegetable, spices, savour substances such as salt or sugar, aroma and fat to obtained chickpea powder is described. However, the addition of none of the additional substances to this mixture is also in the scope of this patent.

Although this patent is related to an additive free instant soup, the addition of any additive to this mixture is covered by this patent.

The addition of vitamin, mineral or other substances beneficial for human health to this mixture at any step or specializing products to special consumer groups by supplementation or specially formulating the mixture for defined age or nutrition groups by increasing specific nutritive compounds and additions made is in the scope of this patent.

At the twelfth step, the mixture is preferably packaged. However, not being packaged is not out of the scope of the patent. The packaging is any natural product or polymer. The packaging with vacuum or modified atmosphere is in the scope of patent.

The thirteenth step will be performed by the consumer and is making the product ready to consume by addition of a water containing liquid at 85-100° C.

The additional wetting tempering and roasting steps that will be used by the production of processed chickpea are in the scope of this patent. Obtaining a thickened liquid with no visible phase separation by the addition of water above 80° C. to the powdered product obtained by the application of at least one wetting two tempering and one roasting operation for any time on crushed chickpeas with a particle size greater than 1 mm is covered by this patent.

All food processing equipments that are utilized by applying the invention to industry are available on the market. The processes described in this patent can easily be applied to the industry.

1) A method for texturizing instant soup by using chickpea flour, wherein chickpeas have undergone at least one time wetting, two different times tempering and at least one time roasting processes before grinding chickpeas to get the chickpea flour.

2) The method for texturizing instant soup according to claim 1, wherein the chickpeas are processed by the steps below:
a. wetting and letting chickpeas swell if they the chickpeas are dry;
b. tempering wetted or fresh the chickpeas for 1-60 minutes at 50-150° C. to obtain first tempered chickpeas;
c. resting the first tempered chickpeas between 1-100 days to obtain rested chickpeas;
d. wetting the rested chickpeas and tempering the rested chickpeas for 1-60 minutes at 50-150° C. to obtain second tempered chickpeas;
e. resting the second tempered chickpeas between 1-100 days;
f. roasting the second tempered chickpeas for 1-60 minutes at 80-300° C. to obtain roasted chickpeas;
g. removing chickpea skin of the roasted chickpeas by an equipment during or after the roasting to obtain removed chickpeas;
h. grinding the removed chickpeas or crushing the removed chickpeas to obtain grinded chickpeas;
and texturizing of soup is achieved by the steps below
i. addition of one or a mixture of substances among milk powder, whey powder, yoghurt powder, cheese powder, dried fruits or vegetable, spices, flavouring substances such as salt or sugar to the chickpea flour;
j. consumption of the mixture by adding liquid at 85-100° C.

3) The method according to claim wherein a thick liquid with no visible phase separation is obtained by adding the liquid with a temperature above 80° C. to the chickpea flour.

4) The method according to claim 2, wherein the chickpeas are grinded by a roller, bladed, bead, or other mill at step h.

5) The method according to claim , wherein the method has a further step where the grinded chickpeas are sieved by a 350 micron sieve after step h.

6) The method according to claim 2, wherein the method has a further step where skins are separated from the roasted chickpeas by cyclone or air flow, depending on the density of the roasted chickpeas.

7) The method according to claim 2, wherein the method has a further step where skins are separated from the roasted chickpeas by sieving.

8) The method according to claim 2, wherein vitamin, mineral or other substances beneficial for human health is added to the mixture at any step of texturizing the instant soup.

9) The method according to claim 2, wherein the mixture is specially formulated for specific age or nutritional groups.
